(19) United States
(12) Patent Application Publication
(10) Pub. No.: US 2025/0008439 A1
(43) Pub. Date: Jan. 2, 2025

(54) COMMUNICATION SYSTEM AND CONTROL METHOD

(71) Applicant: NIPPON TELEGRAPH AND TELEPHONE CORPORATION, Tokyo (JP)

(72) Inventors: Ryo MIYATAKE, Musashino-shi, Tokyo (JP); Kenta ITO, Musashino-shi, Tokyo (JP); Hiroaki KATSURAI, Musashino-shi, Tokyo (JP); Yoichi FUKADA, Musashino-shi, Tokyo (JP); Tomoaki YOSHIDA, Musashino-shi, Tokyo (JP)

(73) Assignee: NIPPON TELEGRAPH AND TELEPHONE CORPORATION, Tokyo (JP)

(21) Appl. No.: 18/693,108

(22) PCT Filed: Sep. 27, 2021
(86) PCT No.: PCT/JP2021/035463

§ 371 Date: Mar. 18, 2024

(51) Int. Cl. H04W 52/02; H02J 7/35; H02J 50/00

(52) U.S. Cl. CPC H04W 52/0235; H04W 52/0261; H02J 7/35; H02J 50/001

(57) ABSTRACT

Provided is a communication system in which at least a master unit of the master unit and a slave unit is driven by a finite power source, in which the master unit notifies the slave unit by including period information indicating a shortest sleep period, which is a shortest possible period of a sleep period, in a communication signal with the slave unit before transitioning to a sleep state in which a power saving operation is possible and communication is disabled, with respect to the sleep period of operating in the sleep state after transitioning to the sleep state, and the slave unit performs a power saving operation during the shortest period notified of by the master unit.

### TECHNICAL FIELD

The present invention relates to a communication system and a control method.

### BACKGROUND ART

Conventionally, Bluetooth Low Energy (BLE) (Bluetooth is a registered trademark, hereinafter the same) is known as means for achieving radio communication at low power. In BLE, a central which has received an advertisement signal from a peripheral issues a connection request to the peripheral which has transmitted the advertisement signal to establish a communication connection (see, for example, NPL 1). In BLE, a peripheral (for example, a radio terminal) and a central (for example, an access point) establish a one-to-one connection and perform communication (generic attribute profile (GATT) communication) (see, for example, NPL 1).

On the other hand, in a radio communication system in which a radio terminal communicates via an access point, sleep control is performed to transition the access point to a sleep state (low power operation state) or to return the access point from the sleep state at a predetermined timing in order to reduce power consumption of a device. In such sleep control, the access point detects an advertisement signal at the timing of returning from the sleep state to establish the communication connection, and therefore the power consumption can be reduced by a period of time during which the access point operates in the sleep state as compared with the case where the sleep control is not performed (see, for example, NPL 2).

### CITATION LIST

### Non Patent Literature

[NPL 1] Chaoshun Zuo, Haohuang Wen, Zhiqiang Lin, Yinqian Zhang, “Automatic Fingerprinting of Vulnerable BLE IoT Devices with Static UUIDs from Mobile Apps,” CCS '19, Nov. 11-15, 2019, London, United Kingdom.
[NPL 2] GAOYANG SHAN AND BYEONG-HEE ROH, “Advertisement Interval to Minimize Discovery Time of Whole BLE Advertisers,” IEEE Received Feb. 4, 2018, accepted Mar. 12, 2018, date of publication Mar. 19, 2018, date of current version Apr. 23, 2018.

### SUMMARY OF INVENTION

### Technical Problem

The conventional sleep control may not always sufficiently suppress the power consumption of the device. FIG. 8 is a diagram illustrating an example of an operation in a case where conventional BLE communication is applied to an access point (central) for saving power by performing a sleep operation after communication. The flow of BLE communication illustrated in FIG. 8 is based on the description of NPL 1. First, a peripheral (radio terminal) transmits a broadcast signal called an advertisement signal (step S90: advertisement). The advertisement signal is an example of a “notification signal.” A central (access point) requests the peripheral to establish a BLE connection in response to reception of the advertisement signal transmitted in step S90 (step S91: connection request). When a connection request is received from the central in step S91 in response to the advertisement in step S90, the peripheral establishes the connection of BLE communication with the central of a request source (step S92: BLE connection establishment). When the BLE connection is established in step S92, the central and the peripheral perform necessary communication by one-to-one BLE communication (generally called “generic attribute profile (GATT) communication”) (step S93), and disconnect the BLE connection when the communication ends (step S94). After the BLE connection is disconnected, the access point performs a sleep operation for power saving (step S95).

On the other hand, the peripheral in the conventional BLE communication continues to transmit the advertisement signal even when the central transitions to the sleep state (steps S96-1, S96-2, S96-3, . . . ), receives a connection request from the central by the advertisement signal (step S96-n) transmitted after the central returns from the sleep state (step S97), establishes a BLE connection with the central again (step S98), and performs GAT communication (step S99).

Thus, in a case where conventional BLE communication is applied to an access point performing a sleep operation, since a radio terminal connected to the access point continues to send an advertisement signal for connection establishment even when the access point is in a sleep state (for example, in the case of Bluetooth Low Energy (BLE) (registered trademark, hereinafter the same) communication), power consumption for this purpose is wasted. As a method for coping with this, transitioning the access point to the sleep state at a constant cycle while synchronizing the access point and the radio terminal is conceivable, but in this case, since the access point returns from the sleep state at a constant cycle even if communication other than synchronous communication is not required, power consumption for this purpose is wasted. Further, in this case, communication cannot be performed at a timing other than the synchronization timing for returning from the sleep state.

In view of the above circumstances, an object of the present invention is to provide a technology capable of further reducing the power consumption of a communication system that operates with a finite power source.

### Solution to Problem

One aspect of the present invention is a communication system in which at least a master unit of the master unit and a slave unit is driven by a finite power source, in which the master unit notifies the slave unit by including period information indicating a shortest sleep period, which is a shortest possible period of a sleep period, in a communication signal with the slave unit before transitioning to a sleep state in which a power saving operation is possible and communication is disabled, with respect to the sleep period of operating in the sleep state after transitioning to the sleep state, and the slave unit performs a power saving operation during the shortest period notified of by the master unit.

One aspect of the present invention is a control method of a master unit and a slave unit in a communication system in which at least the master unit of the master unit and the slave unit is driven by a finite power source, the control method including: notifying, by the master unit, the slave unit by including period information indicating a shortest sleep period, which is a shortest possible period of a sleep period, in a communication signal with the slave unit before transitioning to a sleep state in which a power saving operation is possible and communication is disabled, with respect to the sleep period of operating in the sleep state after transitioning to the sleep state; and performing, by the slave unit, a power saving operation during the shortest period notified of by the master unit.

### Advantageous Effects of Invention

According to the present invention, it is possible to further reduce the power consumption of a communication system that operates with a finite power source.

### BRIEF DESCRIPTION OF DRAWINGS

FIG. 1 is a diagram illustrating a configuration example of a communication system according to a first embodiment.

FIG. 2 is a sequence chart illustrating a flow of radio communication between an access point as a central and a radio terminal as a peripheral while repeating a sleep state.

FIG. 3 is a flowchart illustrating an example of a flow of processing executed by an access point regarding sleep control.

FIG. 4 is a diagram illustrating an example of a correspondence table.

FIG. 5 is a flowchart illustrating an example of a flow of processing executed by a radio terminal regarding sleep control.

FIG. 6 is a diagram illustrating a configuration example of a communication system according to a second embodiment.

FIG. 7 is a diagram schematically illustrating a connect mode and a broadcast mode, which are operation modes of BLE.

FIG. 8 is a sequence chart illustrating a flow of radio communication between a central and a peripheral while repeating a sleep state in conventional BLE communication.

### DESCRIPTION OF EMBODIMENTS

Embodiments of the present invention will be described below with reference to the drawings.

### First Embodiment

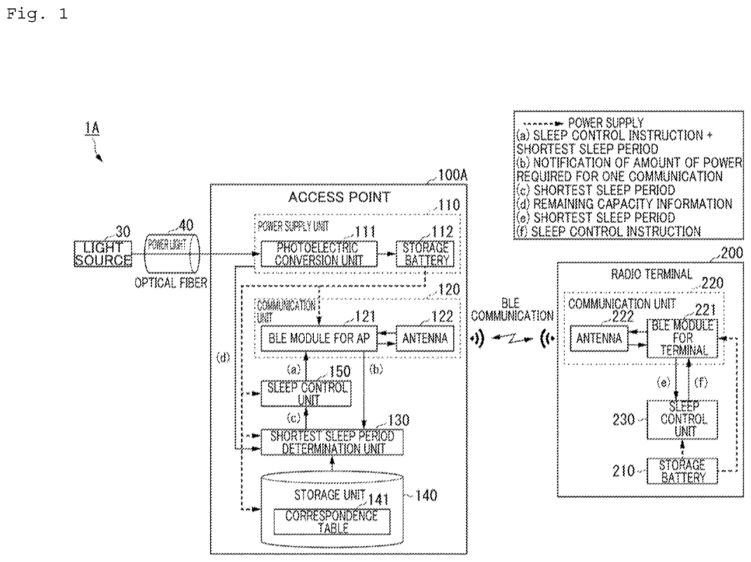

FIG. 1 is a diagram illustrating a configuration example of a communication system 1A according to a first embodiment. The communication system 1A includes an access point 100A, a radio terminal 200, a light source 30, and an optical fiber 40. The access point 100A and the radio terminal 200 are examples of communication devices that operate with finite power sources. The access point 100A and the radio terminal 200 can communicate with each other by radio communication using Bluetooth Low Energy (BLE) (Bluetooth is a registered trademark, hereinafter the same). The access point 100A and the radio terminal 200 suppress power consumption by repeating transition to a sleep state in which a power saving operation is possible and return from the sleep state.

Here, “sleep state” refers to a state in which at least the power supply to the communication function is stopped, and in which it is possible to determine whether or not the conditions for returning from that state have been satisfied, and a state in which the power supply to the communication function is not stopped is defined as a “normal state.” In the following description, the return from the sleep state to the normal state may be referred to as “activation.”

The light source 30 supplies power for charging to the access point 100A by optical power supply. The optical fiber 40 is a transmission line for transmitting light for power supply (power light) output from the light source 30 to the access point 100A.

The configuration of the access point 100A and the radio terminal 200 will be described in more detail below. First, the configuration of the access point 100A will be described. The access point 100A is an example of a “master unit.” The access point 100A includes a power supply unit 110, a communication unit 120, a shortest sleep period determination unit 130, a storage unit 140, and a sleep control unit 150.

The power supply unit 110 is a power source for supplying power for operation to the access point 100A. The power supply unit 110 inputs the power light supplied from the light source 30 via the optical fiber 40, converts the input power light into power, and supplies the power to each unit of the access point 100A. Specifically, the power supply unit 110 includes, for example, a photoelectric conversion unit 111 and a storage battery 112. The storage battery 112 is an example of a “finite power source.”

The photoelectric conversion unit 111 converts the power light input from the optical fiber 40 into power and outputs the power to the storage battery 112. The storage battery 112 is a rechargeable battery. The storage battery 112 may be a battery having a plurality of cells. The storage battery 112 is charged with the power output from the photoelectric conversion unit 111, and supplies the power stored by the charging to each circuit such as the communication unit 120, the shortest sleep period determination unit 130, the storage unit 140, and the sleep control unit 150 in the access point 100A.

The power supply unit 110 also has a function of measuring the remaining capacity of the storage battery 112, and supplies remaining capacity information of the storage battery 112 to the shortest sleep period determination unit 130. The power supply unit 110 may include a solar power generator instead of the photoelectric conversion unit 111, and may be configured to charge the storage battery 112 with power generated by the solar power generator. The power supply unit 110 may include both the photoelectric conversion unit 111 and the solar power generator, and may be configured to supply power to the access point 100A using both.

In addition, the power supply unit 110 may employ a configuration using not only the above-described photoelectric conversion unit 111 and the solar power generator, but also various power generation methods using energy harvesting technology (see, Reference 1 below) such as “visible light power generation,” “dynamic energy power generation,” “thermal energy power generation,” “radio wave energy power generation,” and “power generation by microorganisms, biofuels, microbial fuels, and the like” and a storage battery similar to the storage battery 112. Here, “visible light power generation” is a power generation method using visible light and the like, and “dynamic energy power generation” is a power generation method using electromagnetic induction, a piezoelectric effect, an inverse magnetostriction effect, pressing energy of a switch, and the like (Reference 1: 2016 NTT Data Institute of Management Consulting “Latest Trends in Energy Harvesting,” <URL: https://www.jstage.jst.go.jp/article/sfj/67/7/67_334/art icle/-char/ja/>).

The communication unit 120 is a communication interface for the access point 100A to perform radio communication with the radio terminal 200 by BLE. Specifically, the communication unit 120 includes, for example, a BLE module 121 for an AP and an antenna 122.

The BLE module 121 for an AP is a circuit for implementing digital signal processing related to BLE communication. For example, the BLE module 121 for an AP executes processing for establishing a communication connection with the radio terminal 200 as a central, modulation/demodulation processing of transmission/reception signals, packet processing, and the like. The BLE module 121 for an AP outputs a modulated transmission signal to the antenna 122, acquires a reception signal from the antenna 122, and executes demodulation processing. The antenna 122 converts the transmission signal output from the BLE module 121 for an AP into an analog radio signal and outputs the radio signal, and converts the received radio signal into an electrical signal and supplies the electrical signal to the BLE module 121 for an AP.

The shortest sleep period determination unit 130 determines a minimum required sleep period (hereinafter referred to as a “shortest sleep period”) for a period during which the access point 100A is placed in the sleep state (hereinafter referred to as a “sleep period”). The shortest sleep period is determined on the basis of the remaining capacity of the storage battery 112 and the amount of charge required according to the remaining capacity. Details of the method of determining the shortest sleep period will be described later. The shortest sleep period determination unit 130 notifies the sleep control unit 150 of the determined shortest sleep period.

The storage unit 140 is a storage device such as a hard disk drive (HDD), a solid state drive (SSD), or a flash memory. The storage unit 140 stores various types of information related to the operation of the access point 100A such as a program and various types of setting information executed by the access point 100A. The storage unit 140 stores a correspondence table 141. The correspondence table 141 is information indicating a relationship between the shortest sleep period, the remaining capacity of the storage battery 112, and the amount of charge required according to the remaining capacity.

The sleep control unit 150 performs sleep control of the access point 100A on the basis of the shortest sleep period notified of by the shortest sleep period determination unit 130. Specifically, the sleep control unit 150 controls the access point 100A to enter a sleep state at least during the shortest sleep period. The sleep control unit 150 returns the access point 100A from the sleep state as necessary after the expiration of the shortest sleep period. For example, the sleep state is a state in which at least power supply of the power supply unit 110 to the communication unit 120 is suspended, or a state in which the communication unit 120 operates with less power consumption than in a normal state.

When the access point 100A is transitioned to the sleep state, the sleep control unit 150 notifies the radio terminal 200 of the shortest sleep period notified of by the shortest sleep period determination unit 130. For example, the sleep control unit 150 notifies the radio terminal 200 of the shortest sleep period by including period information indicating the shortest sleep period in a communication signal with the radio terminal 200 before transitioning to the sleep state.

Next, the configuration of the radio terminal 200 will be described. The radio terminal 200 is an example of a “slave unit.” The radio terminal 200 includes, for example, a storage battery 210, a communication unit 220, and a sleep control unit 230. The storage battery 210 is a power source for supplying power for operation to the radio terminal 200. The storage battery 210 may be a rechargeable storage battery similar to the storage battery 112 of the access point 100A, or may be a replaceable storage battery. The storage battery 210 supplies power to various circuits in the radio terminal 200 such as the communication unit 220 and the sleep control unit 230.

The communication unit 220 is a communication interface for the radio terminal 200 to perform radio communication with the access point 100A by BLE. Specifically, the communication unit 220 includes, for example, a BLE module 221 for a terminal and an antenna 222.

The BLE module 221 for a terminal is a circuit for implementing digital signal processing related to BLE communication. For example, the BLE module 221 for a terminal executes processing for establishing a communication connection with the access point 100A as a peripheral, modulation/demodulation processing of transmission/reception signals, packet processing, and the like. The BLE module 221 for a terminal outputs a modulated transmission signal to the antenna 222, acquires a reception signal from the antenna 222, and executes demodulation processing. The antenna 222 converts the transmission signal output from the BLE module 221 for a terminal into an analog radio signal and outputs the radio signal, and converts the received radio signal into an electrical signal and supplies the electrical signal to the BLE module 221 for a terminal.

The sleep control unit 230 performs sleep control of the radio terminal 200 with the shortest sleep period notified of by the access point 100A as a sleep period. Specifically, the sleep control unit 230 causes the radio terminal 200 to operate in a sleep state during the shortest sleep period. For example, the sleep state is a state in which at least power supply of the storage battery 210 to the communication unit 220 is suspended, or a state in which the communication unit 220 operates with less power consumption than in a normal state.

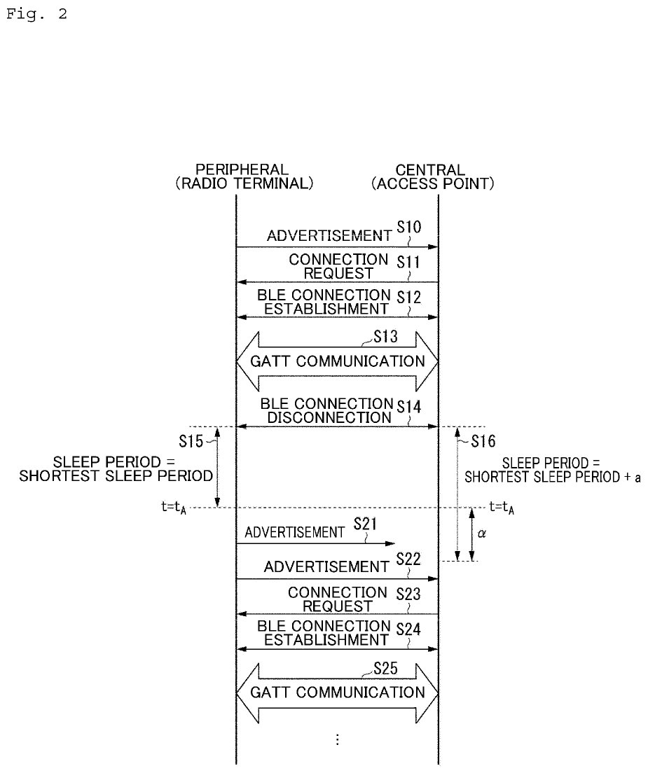

FIG. 2 is a sequence chart illustrating a flow of radio communication between the access point 100A as a central and the radio terminal 200 as a peripheral while repeating a sleep state in the communication system 1A according to the embodiment. First, the radio terminal 200 transmits an advertisement signal (step S10: advertisement). The advertisement signal is an example of a “notification signal.” The access point 100A requests the radio terminal 200 to establish a BLE connection in response to reception of the advertisement signal transmitted in step S10 (step S11: connection request). When a connection request is received from the access point 100A in step S11 in response to the advertisement in step S10, the radio terminal 200 establishes the connection of BLE communication with the access point 100A of a request source (step S12: BLE connection establishment). When the BLE connection is established in step S12, the access point 100A and the radio terminal 200 perform necessary communication by one-to-one BLE communication (generally called “generic attribute profile (GATT) communication”) (step S13), and disconnect the BLE connection when the communication ends (step S14).

Here, the access point 100A estimates the remaining capacity of the storage battery 112 after performing the GATT communication, and determines the shortest sleep period on the basis of the estimated remaining capacity. The access point 100A transmits information indicating the determined shortest sleep period while including the information in a communication signal in GATT communication, thereby notifying the radio terminal 200 of the shortest sleep period. When the BLE connection is disconnected in step S14, the radio terminal 200 transitions to the sleep state with the shortest sleep period notified of by the access point 100A as a sleep period (step S15).

On the other hand, the access point 100A can return from sleep at any timing (t=t_{A}+α) after the shortest sleep period (S15) (t=t_{A}) has elapsed. Here, it is important that a is not required to be determined in advance, and that the access point 100A can set its return timing to any timing on the basis of an arbitrary reference after the shortest sleep period (S15) (t=t_{A}). For example, the access point 100A can return in a case where transmission requirements addressed to the radio terminal 200 occur in the own device, or can return at a predetermined timing, or can return at a random timing generated in the own device. For example, the access point 100A can preset a change in intensity of power light coming from the light source 30 or the like as a trigger and can return on the basis of the trigger, or an external device that generates a return signal for instructing the access point 100A to return from the sleep state can be additionally connected to the access point 100A, and the return signal output from the external device can be used for return. As another configuration, α may be set in advance, and the sleep period (S16) may be determined according to the set value of a. That is, a may be any value of 0 or more. According to such a configuration, since the operation time in the sleep state is always longer than the case of returning from the sleep state at the expiration of the shortest sleep period, the power saving effect can be further enhanced.

The access point 100A is in a sleep state for such a predetermined or subsequently determined sleep period (step S16).

Then, the radio terminal 200 restarts advertisement to the access point 100A when returning from the sleep state. The advertisement signal transmitted after the advertisement restart is received by the access point 100A after the access point 100A returns from the sleep state at a time t=t_{A}+α. That is, in the example of FIG. 2, the advertisement signal of step S21 is not received by the access point 100A, and the advertisement signal of step S22 and subsequent steps is received by the access point 100A. The access point 100A receiving the advertisement signal establishes a BLE connection with the radio terminal 200 and performs GATT communication (steps S23 to S25), similarly to steps S11 to S13. The access point 100A and the radio terminal 200 can reduce power consumption by repeating the flow of advertisement→connection request→BLE connection establishment→GATT communication→BLE connection disconnection→sleep state→advertisement.

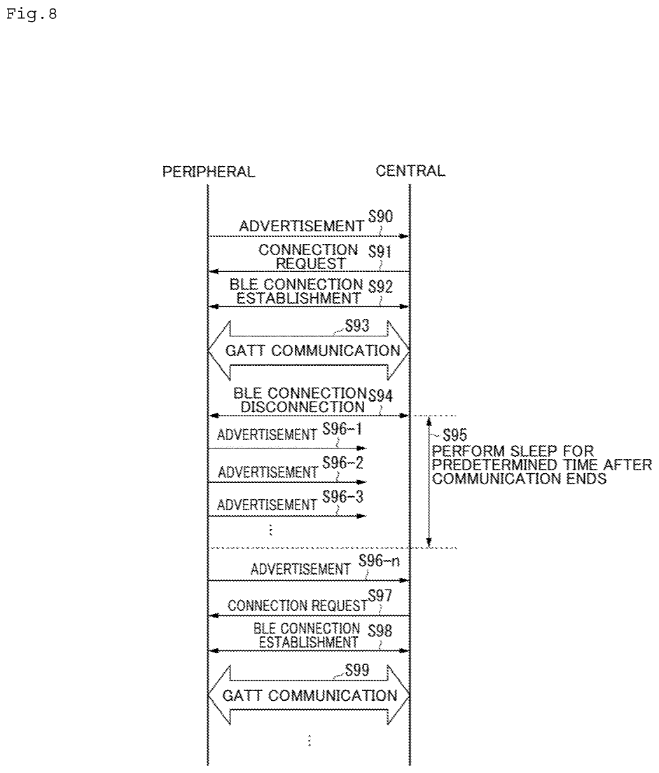

For example, in BLE communication of the conventional method illustrated in FIG. 8, even if the access point (central) performs sleep after disconnection of the BLE connection, the radio terminal (peripheral) continues to transmit the advertisement signal without performing sleep (step S96). However, since the access point is sleeping at this time, the advertisement signal cannot be received, and therefore, there arises a problem that the power of the radio terminal is consumed more than necessary. On the other hand, according to the communication system 1A of the present embodiment, since the radio terminal 200 also performs sleep in synchronization with the access point 100A, at least the power consumption that was wasted in the conventional method can be reduced in the radio terminal 200. For simplicity, one radio terminal 200 is illustrated here, but a plurality of radio terminals 200 may be used.

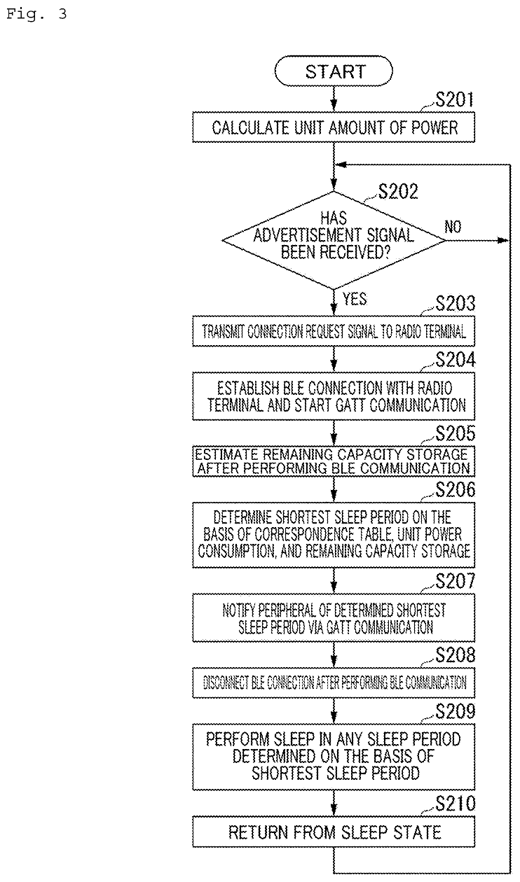

FIG. 3 is a flowchart illustrating an example of a flow of processing executed by the access point 100A regarding sleep control. The flow of FIG. 3 is started in a state in which the access point 100A and the radio terminal 200 have returned from the sleep state and before establishing the BLE communication connection. First, the sleep control unit 150 acquires the amount of power required for the access point 100A to execute a unit amount of communication (hereinafter referred to as a “unit amount of power”) with respect to communication with the radio terminal 200 (step S201).

Here, for simplicity, one BLE communication is assumed to be the unit amount of communication, and the amount of power required for one BLE communication is acquired as the unit amount of power. The information on the unit amount of power acquired here is used to estimate (predict) the remaining capacity of the storage battery 112 after completion of the unit amount of communication before completion of the communication, and more specifically, is used to estimate the remaining capacity of the storage battery 112 at a timing when the access point 100A transitions to the sleep state (hereinafter referred to as a “transition timing”). Therefore, the unit amount of communication is not necessarily required to be the amount of power required for one BLE communication if the remaining capacity of the storage battery 112 can be estimated at the transition timing. If the remaining capacity of the storage battery 112 at the transition timing can be estimated, one BLE communication may be defined in any unit such as one data transmission (or transmission/reception) or transmission of one piece of data.

The sleep control unit 150 may cause the communication unit 120 to actually perform a unit amount of communication or an operation equivalent to the communication, and calculate a value of the unit amount of power by comparing the remaining capacities of the storage battery 112 before and after the communication. In this case, the sleep control unit 150 may omit the calculation of the unit amount of power after the next time in a case where the communication condition does not change by recording the calculation result in the storage unit 140.

Subsequently, the BLE module 121 for an AP determines whether or not an advertisement signal has been received from the radio terminal 200 (step S202). In a case where it is determined here that the advertisement signal has not been received (step S202—NO), the BLE module 121 for an AP repeatedly executes step S202 until the advertisement signal is received from the radio terminal 200. On the other hand, in a case where it is determined that the advertisement signal has been received (step S202—YES), the BLE module 121 for an AP establishes a BLE connection with the radio terminal 200 by transmitting a connection request signal requesting establishment of the BLE connection to the radio terminal 200 (peripheral) transmitting the received advertisement signal (step S203). After the BLE connection is established, the BLE module 121 for an AP starts GATT communication with the radio terminal 200 (step S204).

When GATT communication is started between the access point 100A and the radio terminal 200, the sleep control unit 150 then estimates the remaining capacity of the storage battery 112 after the BLE communication to be executed from now is executed (step S205). Specifically, the sleep control unit 150 acquires the current remaining capacity of the storage battery 112 from the power supply unit 110, and calculates power required for BLE communication to be executed from now on the basis of the unit amount of power. The sleep control unit 150 can estimate the remaining capacity of the storage battery 112 after BLE communication by subtracting the calculated required power from the current remaining capacity.

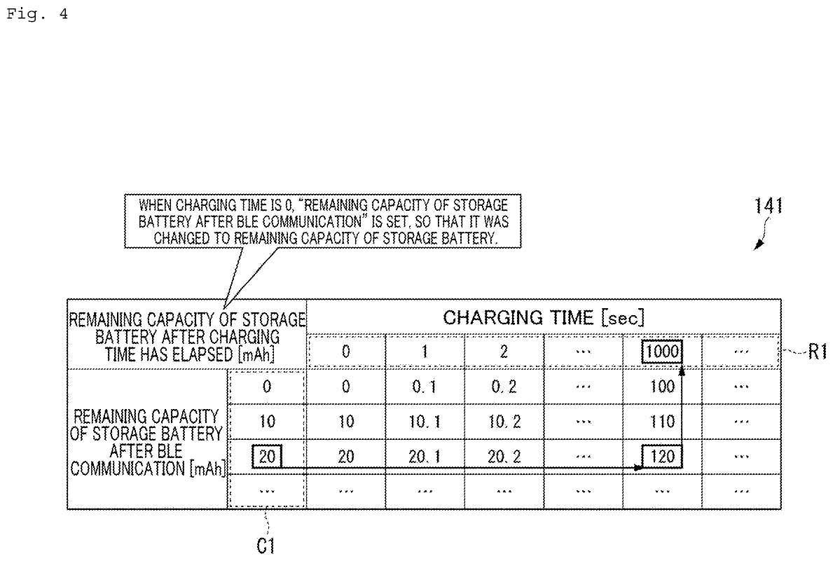

Subsequently, the sleep control unit 150 refers to the correspondence table 141 held in the storage unit 140, and determines the shortest sleep period on the basis of the unit amount of power and the remaining capacity of the storage battery 112 estimated in step S205 (step S206). Here, an example of the correspondence table 141 is illustrated in FIG. 4. In the correspondence table 141 of FIG. 4, a first column C1 represents the remaining capacity of the storage battery 112, a first row R1 represents the charging time of the storage battery 112, and the other rows and columns represent the remaining capacity of the storage battery 112 with the corresponding remaining capacity after charging for the corresponding charging time. For example, the correspondence table 141 can be created by operating the access point 100A on a preliminary test basis before starting the operation of the communication system 1A and measuring the power consumption and the remaining capacity of the storage battery at that time to create a table.

Here, for example, in the case where the content of the correspondence table 141 is registered as shown in FIG. 4, it is assumed that the unit amount of power (amount of power required for one BLE communication in the present embodiment) is 120 mAh. In this case, for example, in a case where one BLE communication is to be performed when the remaining capacity of the storage battery 112 is 140 mAh, the sleep control unit 150 can estimate that the remaining capacity of the storage battery 112 after one BLE communication is performed is 20 mAh (=140 mAh-120 mAh) by subtracting 120 mAh which is a unit amount of power from 140 mAh which is the current remaining capacity.

Then, the sleep control unit 150 can refer to the correspondence table 141 on the basis of the estimated remaining capacity of 20 mAh, recognize that a charging time required for increasing the remaining capacity of the storage battery 112 from 20 mAh of the estimated remaining capacity to 120 mAh which is a unit amount of power is 1000 seconds, and determine the charging time 1000 seconds as the shortest sleep period. By transitioning to the sleep state for the shortest sleep period thus determined and performing charging, the access point 100A can return from the sleep state in a state in which at least one BLE communication can be performed.

The description will now return to FIG. 3. Subsequently, the sleep control unit 150 transmits information indicating the shortest sleep period determined in step S206 while including the information in a communication signal of BLE communication to be performed, thereby notifying the radio terminal 200 of the shortest sleep period (step S207). More specifically, the sleep control unit 150 transmits information indicating the shortest sleep period while including the information in a header part or a data part of the BLE communication packet. In a case where there is no BLE communication to be performed before sleep, communication for notifying the radio terminal 200 of the shortest sleep period may be newly generated. The shortest sleep period notified to the radio terminal 200 here is used as a sleep period of the radio terminal 200. The BLE module 121 for an AP disconnects the BLE connection with the radio terminal 200 when BLE communication ends (step S208).

Subsequently, the sleep control unit 150 controls the access point 100A to perform sleep in any sleep period determined on the basis of the shortest sleep period (step S209), and returns the access point 100A from the sleep state when the sleep period expires (step S210).

According to such processing, the sleep control unit 150 can put the access point 100A to sleep for the shortest sleep period until at least a unit amount of power for communication is charged, and return the access point 100A from the sleep state at any timing when the period elapses. Thus, more power consumption can be reduced than when the access point 100A is brought into a sleep state for a specified time. Further, the sleep control unit 150 can bring the radio terminal 200 into a sleep state for the shortest sleep period in synchronization with the access point 100A. Thus, the radio terminal 200 transitions to the sleep state in synchronization with the access point 100A, and the number of times of transmitting the advertisement signal is reduced, thereby reducing power consumption.

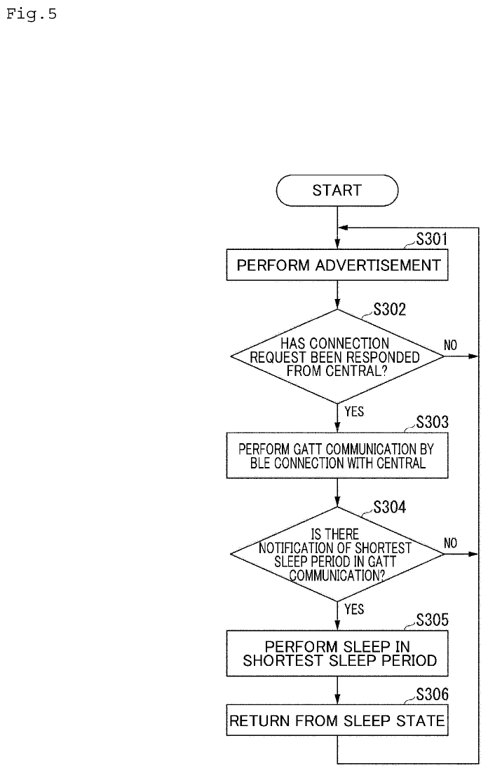

FIG. 5 is a flowchart illustrating an example of a flow of processing executed by the radio terminal 200 regarding sleep control. The flow of FIG. 5 is started at least in a state in which the radio terminal 200 has returned (activated) from the sleep state and before establishing the BLE communication connection with the access point 100A. First, the communication unit 220 performs advertisement (step S301), and determines whether or not a connection request has been responded from the access point 100A to the performed advertisement (step S302).

Here, in a case where it is determined that the connection request has not been responded from the access point 100A (step S302—NO), the communication unit 220 repeatedly executes step S301 until it is determined that the connection request has been responded from the access point 100A. On the other hand, in a case where it is determined that the connection request has been responded from the access point 100A (step S302—YES), the communication unit 220 establishes a BLE connection with the access point 100A, and performs GATT communication (step S303). After performing the GATT communication, the BLE connection between the access point 100A and the radio terminal 200 is disconnected.

Then, the sleep control unit 230 determines whether or not the shortest sleep period has been notified of by the access point 100A in GATT communication (step S304). Here, in a case where it is determined that the shortest sleep period has not been notified (step S304—NO), the sleep control unit 230 returns the processing to step S301. On the other hand, in a case where it is determined that the shortest sleep period is notified of by the access point 100A (step S304—YES), the sleep control unit 230 uses the notified shortest sleep period as a sleep period, transitions the radio terminal 200 to a sleep state during the sleep period (step S305), and returns the radio terminal 200 from the sleep state when the sleep period expires (step S306).

In step S301, the communication unit 220 may be configured to perform advertisement in a case where a transmission requirement to the central occurs in the radio terminal 200. For example, in this case, a step of determining whether or not a transmission requirement to the central occurs may be added between the start and step S301, and the communication unit 220 may repeat the same step until the determination result becomes true, and proceed to step S301 in a case where the determination result is true.

With the communication system 1A according to the first embodiment configured in this manner, in a case where at least the access point 100A of the access point 100A and the radio terminal 200 is driven by a finite power source, the shortest sleep period is determined when the access point 100A transitions to a sleep state, the shortest sleep period is notified to the radio terminal 200 by including information indicating the determined shortest sleep period in a communication signal with the radio terminal 200 before transitioning to the sleep state, the radio terminal 200 operates in the sleep state during the shortest sleep period notified of by the access point 100A, and thereby the power consumption of the access point 100A and the radio terminal 200 can be reduced while securing the communication timing of the access point 100A and the radio terminal 200.

### Second Embodiment

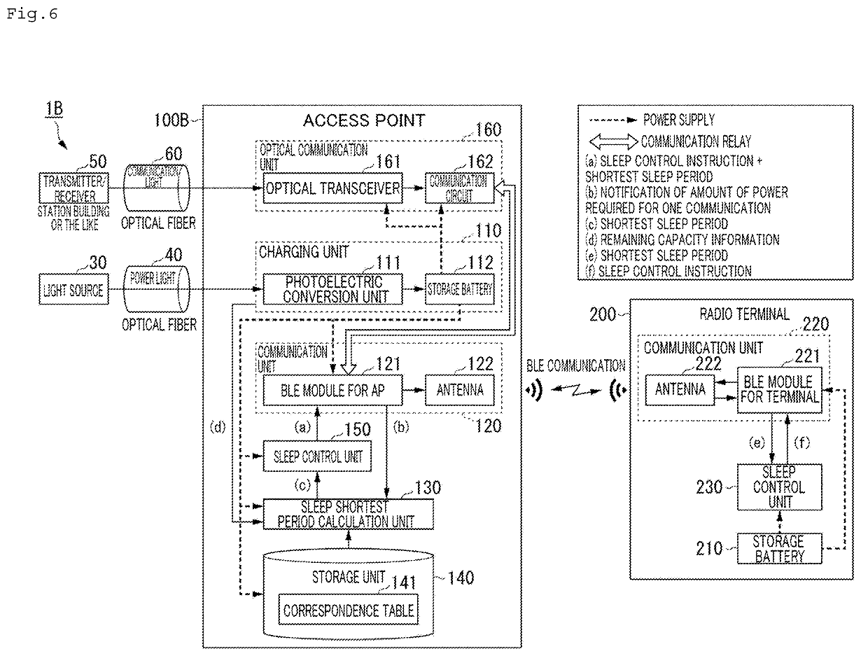

FIG. 6 is a diagram illustrating a configuration example of a communication system 1B according to a second embodiment. The communication system 1B is different from the communication system 1A according to the first embodiment in that it includes an access point 100B instead of the access point 100A, and further includes an optical transmitter/receiver 50 and an optical fiber 60. The access point 100B is different from the access point 100A in that it further includes an optical communication unit 160. Since other functional units are the same as those of the first embodiment, the same reference numerals as those in FIG. 1 are used to omit the description.

The optical transmitter/receiver 50 performs optical communication with the access point 100B via the optical fiber 60. For example, the optical transmitter/receiver 50 is an optical line terminal (OLT) installed in a station building or the like. The optical fiber 60 is an optical fiber for communication. Although the optical fiber 40 for power supply and the optical fiber 60 for communication are described separately here, in a case where power supply light and communication light are multiplexed by wavelength division multiplexing, the optical fiber 40 and the optical fiber 60 may be the same optical fiber.

The optical communication unit 160 communicates with the optical transmitter/receiver 50 via the optical fiber 60. Also, the optical communication unit 160 communicates with the radio terminal 200 via the communication unit 120. The optical communication unit 160 may relay the communication of the radio terminal 200 to the optical transmitter/receiver 50, or may relay the communication of the optical transmitter/receiver 50 to the radio terminal 200. The optical communication unit 160 is operated by the power supplied from the storage battery 112, and the power supply is stopped in the sleep state similarly to the communication unit 120.

More specifically, the optical communication unit 160 includes, for example, an optical transceiver 161 and a communication circuit 162. The optical transceiver 161 inputs and outputs an optical signal to and from the optical fiber 60. The optical transceiver 161 converts the optical signal input from the optical fiber 60 into an electrical signal and outputs the electrical signal to the communication circuit 162, and converts the electrical signal output from the communication circuit 162 into an optical signal and outputs the optical signal to the optical fiber 60.

The communication circuit 162 is a circuit for implementing transmission and reception of data by performing modulation/demodulation, compensation, protocol processing, and the like of an electrical signal input and output to and from the optical transceiver 161. The communication circuit 162 may relay communication between the optical transmitter/receiver 50 and the radio terminal 200 by exchanging transmission and reception data with the BLE module 121 for an AP. Further, the communication circuit 162 may include a function for operating the access point 100B as an optical network unit (ONU) to the optical transmitter/receiver 50 as an optical line terminal.

Also in the second embodiment, the timing at which the access point 100B returns from the sleep state may be set to any timing on the basis of an arbitrary reference. For example, the access point 100B according to the second embodiment can return from the sleep state in the following manner in addition to the method described in the first embodiment. For example, the access point 100B can return using a signal supplied from the transmitter/receiver 50 as a trigger in a case where transmission requirements addressed to the access point 100B and the radio terminal 200 occur in the transmitter/receiver 50 or the like. Also, for example, in a case where the transmitter/receiver 50 sends a signal requesting return from the sleep state even if no transmission requirement occurs, the access point 100B can also return at the timing of receiving the signal. As described above, in a case where a signal requesting the access point 100B to return from the sleep state is supplied from the transmitter/receiver 50, the signal may be transmitted using the communication light 60.

With the communication system 1B according to the second embodiment configured in this manner, power consumption by the access point 100B and the radio terminal 200 can be reduced, and the access point 100B operating by a finite battery can be connected to an optical communication line, similarly to the communication system 1A according to the first embodiment. In this case, the radio terminal 200 connected to the access point 100B can communicate with another device connected to an optical communication line via the optical transmitter/receiver 50 in addition to communication with the access point 100B or another radio terminal 200 connected to the access point 100B.

### Modification Example Common to Each Embodiment

The modification example common to the communication system 1A according to the first embodiment and the communication system 1B according to the second embodiment will be described below. In the following description, alphabetic characters (specifically, “A” or “B”) that indicate different embodiments are omitted unless otherwise distinguished. For example, in a case where the communication system 1A according to the first embodiment and the communication system 1B according to the second embodiment are not distinguished from each other, both are collectively described as the communication system 1.

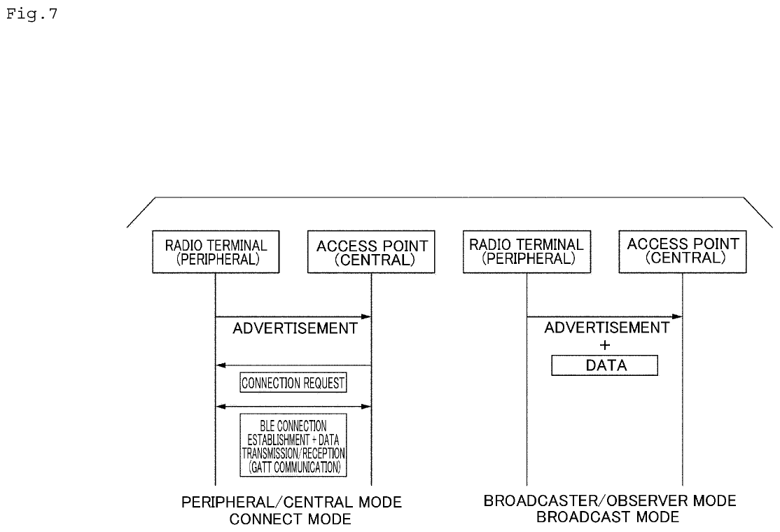

FIG. 7 is a diagram schematically illustrating a connect mode and a broadcast mode, which are operation modes of BLE. The connect mode is an operation mode in which bidirectional communication is performed, and a peripheral (radio terminal 200 in the embodiment) advertises, and a central (access point 100 in the embodiment) requests the advertised peripheral to establish a communication connection. On the other hand, the broadcast mode is an operation mode in which unidirectional communication (peripheral-central) is performed, and in which the peripheral transmits transmission data to the central by putting the transmission data on an advertisement signal. That is, the communication system 1 according to the embodiment assumes a case where the access point 100 and the radio terminal 200 communicate with each other in the connect mode.

In the connect mode, since the peripheral needs to wait for a connection from the central side, it is generally impossible to perform deep sleep, making it difficult to suppress power consumption. On the other hand, in the communication system 1 according to the embodiment, as described above, the access point 100 determines a shortest sleep period on the basis of the estimated remaining capacity of the storage battery 112 and notifies the radio terminal 200 of the determined shortest sleep period, and the access point 100 and the radio terminal 200 are synchronously transitioned to the sleep state on the basis of the shortest sleep period, thereby reducing the power consumption.

In the communication system 1 according to the embodiment configured in this manner, in a case where the update frequency of the shortest sleep period is lower than the communication frequency between the access point 100 and the radio terminal 200, BLE communication between the access point 100 and the radio terminal 200 may be configured to be performed in a broadcast mode instead of the connect mode. Since GATT communication or the like is omitted in the broadcast mode, the broadcast mode consumes less power than in the connect mode. Therefore, by performing the BLE communication in the broadcast mode instead of the connect mode, the power consumption of the communication system 1 according to the embodiment can be further reduced.

However, since the communication in the broadcast mode is unidirectional communication from the radio terminal 200 to the access point 100, the access point 100 cannot notify of the shortest sleep period in the broadcast mode. Therefore, the access point 100 may be configured to communicate with the radio terminal 200 in the connect mode in the case of updating the shortest sleep period, and to communicate with the radio terminal 200 in the broadcast mode otherwise. For example, in a case where the shortest sleep period is updated once every 100 times of communication between the access point 100 and the radio terminal 200, the 100 times of communication are performed in the broadcast mode, and the subsequent one time of communication is performed in the connect mode, and the information of the shortest sleep period can be included in the communication signal in the connect mode.

With the communication system 1 according to the above-described embodiment or the modification example thereof, while the power consumption of the communication system 1 that operates with a finite power source is reduced by the power saving operation by sleep of the access point 100 and the radio terminal 200, the access point 100 side can perform communication by shifting from a sleep state to a non-sleep state at any timing. Therefore, power saving and highly flexible communication are possible.

Communication between the access point 100 (master unit) and the radio terminal 200 (slave unit) may be wired communication. In this configuration, the access point 100 includes a “wired communication module for a master unit” instead of the “BLE module 121 for an AP” illustrated in FIGS. 1 and 6, and the radio terminal 200 includes a “wired communication module for a terminal” instead of the “BLE module for a terminal.” A configuration is considered in which the wired communication module for a master unit and the wired communication module for a terminal are connected with a wired cable, and wired communication is performed instead of radio communication by BLE.

The “wired communication module for a master unit” and the “wired communication module for a terminal” are communication modules that enable wired communication between the access point 100 (master unit) and the radio terminal 200 (slave unit). The “wired communication module for a master unit” and the “wired communication module for a terminal” transmit and receive communication signals between the access point 100 (master unit) and the radio terminal 200 (slave unit). In addition, the wired cables to be used include optical fibers, local area network (LAN) cables, Universal Serial Bus (USB) cables, and the like, but are not limited to these cables, but the cables are not limited to these, and any type of wired cable available in the market where communication is possible can be used.

A part or all of the access point 100 and the radio terminal 200 described above may be implemented by a computer. In such a case, a program for implementing the functions may be recorded in a computer-readable recording medium, and the functions may be implemented by loading the program recorded on this recording medium to a computer system, and executing the program. Note that the “computer system” mentioned herein includes an OS and hardware such as peripheral devices. In addition, the “computer-readable recording medium” refers to a portable medium such as a flexible disk, a magneto-optical disk, a ROM, or a CD-ROM or a storage device such as a hard disk that is built into the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. Also, the foregoing program may be for implementing some of the functions described above, may be implemented in a combination of the functions described above and a program already recorded in a computer system, or may be implemented with a programmable logic device such as a field programmable gate array (FPGA).

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention is applicable to communication systems that operate with finite power sources.

### REFERENCE SIGNS LIST

1, 1A, 1B Communication system
100, 100A, 100B Access point
110 Power supply unit
111 Photoelectric conversion unit
112 Storage battery
120 Communication unit
121 BLE module for AP
122 Antenna
130 Shortest sleep period determination unit
140 Storage unit
141 Correspondence table
150 Sleep control unit
160 Optical communication unit
161 Optical transceiver
162 Communication circuit
200 Radio terminal
210 Storage battery
220 Communication unit
221 BLE module for terminal
222 Antenna
230 Sleep control unit
30 Light source
40 Optical fiber (for power supply)
50 Optical transmitter/receiver
60 Optical fiber (for communication)

1. A communication system in which at least a master unit of the master unit and a slave unit is driven by a finite power source,
wherein the master unit notifies the slave unit by including period information indicating a shortest sleep period, which is a shortest possible period of a sleep period, in a communication signal with the slave unit before transitioning to a sleep state in which a power saving operation is possible and communication is disabled, with respect to the sleep period of operating in the sleep state after transitioning to the sleep state, and the slave unit performs a power saving operation during the shortest period notified of by the master unit.

2. The communication system according to claim 1, wherein the master unit is configured to return from the sleep state at any timing after expiration of the shortest sleep period.

3. The communication system according to claim 1, wherein the master unit includes
a rechargeable storage battery as the finite power source,
a processor; and
a storage medium having computer program instructions stored thereon, when executed by the processor, perform to:
determine the shortest sleep period on the basis of a remaining capacity of the storage battery and an amount of charge required according to the remaining capacity.

4. The communication system according to claim 3, wherein the computer program instructions further perform to estimates a remaining capacity of the storage battery after a unit amount of communication is executed and determines a time required for charging an amount of charge required according to the estimated remaining capacity as the shortest sleep period on the basis of an amount of power required for implementing the unit amount of communication between the master unit and the slave unit and a current remaining capacity of the storage battery.

5. The communication system according to claim 1, wherein the master unit further includes
a power supply unit that supplies power for charging to the storage battery by power supply means in which solar power generation, optical power supply, or other energy harvesting technology is applied.

6. The communication system according to claim 1, wherein the master unit further includes
an optical communication unit for connecting to an optical line terminal, and
a communication circuit that implements a function as an optical network unit.

7. The communication system according to claim 1, wherein, in the communication system,
the master unit establishes a communication connection by requesting a connection to a slave unit that has transmitted a received notification signal, and
the slave unit implements the power saving operation by not transmitting the notification signal during the shortest sleep period notified of by the master unit.

8. A control method of a master unit and a slave unit in a communication system in which at least the master unit of the master unit and the slave unit is driven by a finite power source, the control method comprising:
notifying, by the master unit, the slave unit by including period information indicating a shortest sleep period, which is a shortest possible period of a sleep period, in a communication signal with the slave unit before transitioning to a sleep state in which a power saving operation is possible and communication is disabled, with respect to the sleep period of operating in the sleep state after transitioning to the sleep state; and
performing, by the slave unit, a power saving operation during the shortest period notified of by the master unit.
